(19) United States
(12) Patent Application Publication
(10) Pub. No.: US 2006/0237075 A1
(43) Pub. Date: Oct. 26, 2006

(54) Vacuum drainage system

(75) Inventor: Reinhold Betz, Tostedt (DE)

Correspondence Address: DENNISON, SCHULTZ & MACDONALD, 1727 KING STREET, SUITE 105, ALEXANDRIA, VA, 22314, US

(73) Assignee: Roediger Vakuum- und Haustechnik GmbH

(21) Appl. No.: 11/392,940

(22) Filed: Mar. 30, 2006

(30) Foreign Application Priority Data
Apr. 20, 2005 (DE) 10 2005 018 449.9

(51) Int. Cl. F16K 15/14

(52) U.S. Cl. 137/846

(57) ABSTRACT

The invention concerns a vacuum drainage system with a vacuum line connected with a vacuum source, in which a vacuum valve (10) is arranged between a collection point collecting accumulated waste water and the vacuum source that exhibits a housing, which exhibits a vacuum side housing part (53) added to the vacuum side of the vacuum line as well as a converged housing (51) part added to the converge-sized vacuum line, whereby preferably a flexible, especially tube-like first element (12) of the vacuum valve is arranged in the housing, admittable with pressure between the housing and available space (48) of the first element and with the closed vacuum valve, the first element is pulled together by caulk running preferably linear or lamellar to the longitudinal axis of the area (18,19) of the first element, is proposed, that a check valve (64) blocking the back flush of waste water in the vacuum-sided cabinet section (53) of the vacuum valve (10).

### BACKGROUND OF THE INVENTION

The invention concerns a vacuum drainage system with a vacuum line connected with a vacuum source, in which a vacuum valve is designed between a collection point collecting accumulated waste water and the vacuum source that exhibits a housing, which exhibits a vacuum side housing part added to the vacuum side of the vacuum line, as well as a converged housing part added to the converge-sized vacuum line, whereby preferably a flexible, especially tube-like first element of the vacuum valve is arranged in the housing, admittable with pressure between the housing and the available space of the first element and with the closed vacuum valve, the first element is pulled together with caulk running preferably linear or lamellar to the longitudinal axis of the area of the first element.

For the vacuum canalization, it is necessary to siphon off accumulated waste water via a vacuum valve after flushing in collection points, such as sinks, toilet bowls, or urinals. According to the state of the art, mechanical valves are therefore used, as such, which cover a tappet, a valve piston as well as a valve seat.

Thereby, the valve itself is activated by applying pressure to a membrane. Adequate valves are constructively costly and voluminous, so that an extensive need for space is necessary.

A vacuum valve for vacuum drainage is taken from EP-A-0 937 926. An adequate vacuum valve serves a high dependability with easy assembly. A compact assembly is given at the same time.

The available invention is based on the task to develop a vacuum drainage system, described before, that the vacuum valve is also secured with an inadequate vacuum on the vacuum-sided housing part, that the vacuum line is blocked to the necessary extent.

For solving the task, the invention essentially proposes that a back flush of waste water blocked by a check valve is arranged in the vacuum-sided housing part of the vacuum valve. Therefore, it is especially proposed that the vacuum-sided housing part is a lug of the housing.

The check valve ensures that if low pressure arises in the vacuum side, the check valve is closed, and therefore no fluid can flow into the vacuum valve, whereby, otherwise, the risk arises that the closed vacuum valve is opened by the back flow of fluid. This might lead to the vacuum drainage system not working properly, especially since fluid can flush back to the collection point and the point of origin respectively, for example to a sink or toilet bowl.

Indeed, it is known to prevent the back flush of fluid via blocking valves. These, however, are detached from vacuum valves, arranged in fluid leading lines and also are not assigned to vacuum systems. So, for example, DE-A-197 44 040 is taken from a valve installation for a washer cleaning installation in automobiles, from which a check valve in a connector part is arranged, which should prevent a back flush of cleaning fluid.

DE-T-600 17 270 proposes a serial design of check valves to prevent a secure backflow during water supply, containing powder or small stone fragments. According to DE-A-33 45 599, check valves are arranged for flasks for the vacuum-shape process, which are operated via an angle lever.

### SUMMARY OF THE INVENTION

According to the vacuum drainage system developed by the invention, the check valve is especially a flexible element, such as containing elastomer material or something like it, which consists of two sides of an isosceles triangle in a first longitudinal section lengthwise and in sealing position, and exhibits a second longitudinal section, displaced to the first one at 90°, having the geometry of a U.

In other words, the flexible element in closed position exhibits the geometry of an isosceles triangle in the first lateral view and the geometry of a quadrangle in a second lateral view displaced to the first one at 90°.

The check valve should preferably stretch in a tube-like section or lug of the hose valve's housing. The section and the lug respectively merge in the vacuum line of the vacuum drainage system.

The flexible element is dimensioned and designed in such a way that the check valve is open if a lower pressure on the vacuum line occurs. If fluid flows back, however, the check valve is thereby closed, in that water manages to flow in the gap between the exterior space of the check valve and interior space of the tube-like section and/or lug of the vacuum valve's housing. Hereby, forces affect the outer sides of the check valve, thus closing it.

It is especially proposed that the second flexible element, built by the check valve, exhibits a hollow cylindrical base section, from which, in closed position of the check valve, two diametrically-opposed hollow cylindrical sections exhibiting the geometry of a triangle in the lateral view of the flexible element are each connect with a peak arising, by flat sections, which are separated in the area of one straight line connected with the peaks of the hollow cylindrical sections. The edges running along the straight line of the flat sections are therefore especially designed as seals in order to improve the sealing function of the flexible second element, as well as the check valve.

The first and/or second flexible element especially consists of elastomer material, whereby it concerns a spraying part in each case.

### BRIEF DESCRIPTION OF THE DRAWINGS

Further details, advantages and characteristics of the invention not only result from the claims of the characteristics—in and of themselves and/or in combination—but also from the following description of a preferred example taken from the diagram.

Shown are:

FIG. 1 a lateral cross-section through a vacuum valve,

FIG. 2 a top view of a check valve,

FIG. 3 a lateral view of the check valve according to FIG. 2 and

FIG. 4 a cut along the line IV-IV in FIG. 3

### DESCRIPTION OF THE PREFERRED EMBODIMENTS

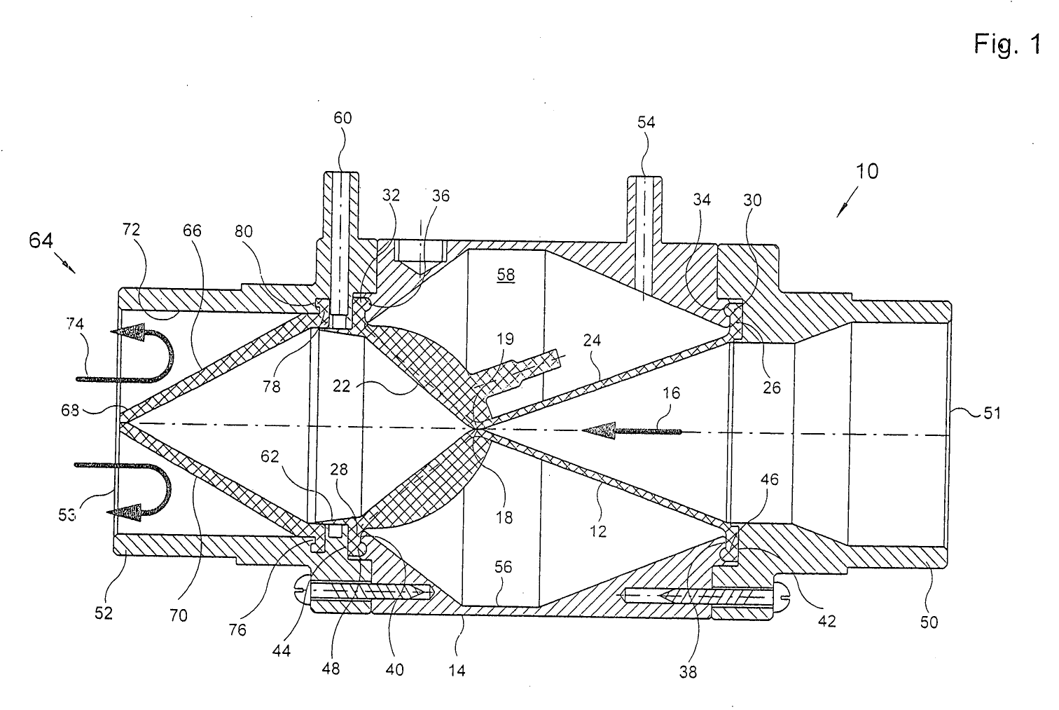

FIG. 1 exhibits a lengthwise section through a vacuum valve 10 of a vacuum drainage installation, with which a toilet bowl or a sink, for example, is emptied. The vacuum valve 10 is arranged in a vacuum line between a point of origin being a collection point, such as the toilet bowl or sink, and a vacuum source to siphon off waste water due to low pressure in the vacuum line. To open the vacuum line, so to siphon off the collected waste water, a control valve opens the vacuum valve 10. The vacuum valve 10 works without mechanically working sliders, pistons or the like, and covers a flexible, preferably tube-like first element 12 as a closing element, which can be clamped in a housing 14 in such a way that the element 12 experiences a compression in the axial direction (arrow 16). The element 12 lies in a linear area 18, 19 caulking on each other, as shown in the diagram.

The flexible element 12 is thereby pre-formed in such a way that the linear and lamellar area does not only preferably exhibit a bended course, but also an eccentric one, so that the element 12 itself consists of sections 22, 24 of different lengths, which are divided by the sealing area 18, 19.

As the diagram makes clear, each section 22, 24, in a lengthwise section, exhibits an isosceles triangle-formed geometry with a combined peak, which is built by the sealing area 18, 19.

Therefore, the sections 22, 24 exhibit triangle geometry in the top view shown. In the view rotated to 90°, therefore perpendicular to the level of the drawing, an isosceles trapezium shape or quadrangle shape results. Insofar, however, as the principle construction of EP-A-0 937 926 is referred to, whose display is referred to explicitly.

The flexible element 12 exhibits an edge 26, 28 revolving and U-shaped in the cut in the area of both of its ends, whose outer sides 30, 32, each running in a lengthwise direction (arrow 16), engages with a revolving flute 34, 36, which originates from the end face 38, 40 of the housing 14.

Along the outer side of each outer leg 42, 44 of the U-shaped edge 26, 28 lies against a revolving ring-shaped section 46, 48 of a tube-like lug 50, 52, which is screwed to the housing 14 in the example. An integral design is also possible.

In other words, the edge 26, 28, stretched across to the lengthwise direction of the flexible element 12, is wedged between the end face 38 and 40 respectively of the housing 14 and the tube-like lug 50 and 52, respectively. Thereby, the distance between the end faces 42, 44 of the case 14 should be smaller than the length of the flexible element 12 in relaxed position. Therefore, it is ensured that at the fixing of flexible element 12 between the housing 14 and the tube-like lugs 50, 52, a compression of the flexible element 12 results, which enforces the sealing effect between the overlapping sealing areas 18, 19 when the valve 10 is closed. Furthermore, a section, not represented in closer detail, may originate from section 22 exhibiting a magnet that serves as impulse count.

The lug 50 of housing 14 exhibits the converging opening 51 and the lug 52, the vacuum-sided opening 53 of the vacuum valve 10 or passes into it.

The housing 14, furthermore, exhibits a connector 54, which meets between the flexible element 12 and the revolving space 58 of the interior wall of case 54.

The space 58 can be pressurized to the necessary extent, which means that, with low pressure, when the valve should open, the areas 18, 19 of the tube-like element 12 are distanced from each other. In this case, fluid, which is siphoned off, can flow through the vacuum valve 10, whereby the tube-like lug 50 is connected with a siphoned-off point of origin, such as toilet bowl and the tube-like lug 52 with a vacuum line.

Furthermore, the possibility exists to charge space 58 with atmospheric pressure and excess pressure respectively to allow an increased sealing impact with a closed valve 10. However, especially, the connector 54 is connected with a help valve over which a connection with a vacuum line occurs when the vacuum valve 10 is opened.

In closing position, atmosphere pressure flows in the space 58 via the control valve, whereby the necessary closing effect is achieved.

Furthermore, the further vacuum lug, leading to one control valve, comes from the vacuum-sided area of the housing 14 and the vacuum-sided revolving tube-like section 52 respectively. The connection 60 is pressurized with low pressure, as far as a vacuum occurs vacuum-sided. In order for fluid to not be able to flow in the connection 60 during the opening of the valve 10, it is closeable open-sided from a lip 62 of the section 22 of the flexible element 12, when fluid flows to the vacuum side (opening 53) with open valve 10. Therefore, the lip 62 functions as a check valve.

Should the vacuum line not have the necessary low pressure to siphon off fluid and solids to the necessary extent, the risk occurs that fluid flushes back to the vacuum valve 10 through the vacuum line and the tube-like lug 52 with the consequence that the vacuum valve 10, which means the flexible element 12, could hereby be opened and therefore fluid could flow back to the point of origin, so in the opposite direction to the direction of the arrow 16. To prevent this, the vacuum valve 10, i.e. the flexible first element 12 is inserted downstream to a check valve 64 that stretches in the lengthwise direction of the tube-like lug 52 in the example.

The check valve 64 is preferably a flexible second element, in which, in principle, can correspond to section 24 of the flexible first element 12 of the vacuum valve 10. The adequate flexible second element 66 is thereby pre-designed in such a way that the vacuum-lined continued edges 68 lie in a linear pattern on each other, so that consequently a rectangle-shaped geometry results from a triangle geometry with a closed check valve 64 according to section 24 in the drawing plane and in the view perpendicular to the drawing plane.

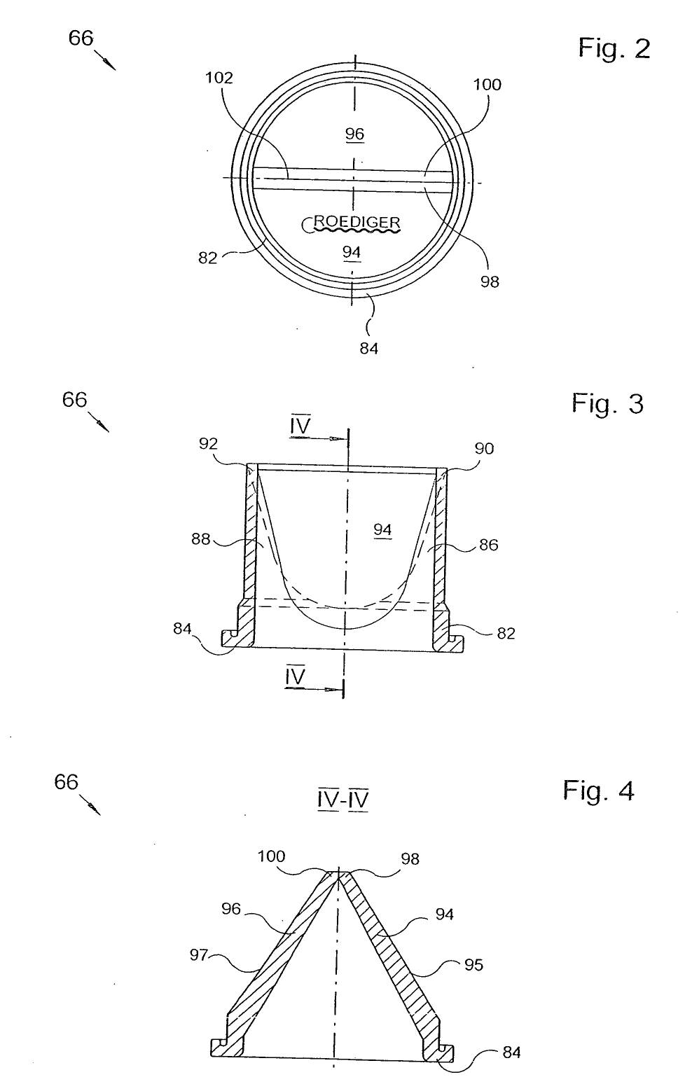

FIGS. 2 to 4 once again exhibit the check valve 66, also called a beaked-valve, which especially consists of elastomer material, and it is a spray part. The check valve 66 exhibits a hollow cylindrical basic section 82 which is limited by an edge 84 exhibiting a U-shape in the cut, over which, corresponding to the sections 22, 24 of the flexible first element 12, the check valve 24 is applicable in an adequate geometrically fitted flute 80 of the tube-like lug 52 to fix the hose valve 66. Outer leg 78 of the edge 84 intervenes in the flute 80.

Two diametrically-opposed first sections 86, 88 come from the base section 82, with each following a section of a hollow cylinder and ends in a peak 90, 92 across the edge 84.

The sections 86, 88 exhibit the check valve 66 in a lateral view, as well as the geometry of an isosceles triangle in the drawing plane.

The sections 86, 88 are connected with sections 94, 96, which are planned outside. According to FIG. 4's cut construction, the sections 94, 96 can go towards their clear ends, which connect the peaks 90, 92 of the sections 86, 88, and rejuvenate in their thickness to show a desired flexibility. The sections 94, 96 are separated from each other along a straight line connecting the peaks 90, 92 to perform the function of a valve.

In the drawing designs, the check valve 66 is shown in closed position, so that, consequently, the edges 98, 100 of the sections 94, 96 lie next to each other along the straight line running between the peaks 90, 92. The edges 98, 100 are thereby preferably built as sealing lips.

The check valve 66, preferably containing elastomer material as mentioned by the invention, is a spraying part where the opening is subsequently punched, so the edges 98, 100, connected with each other after spraying, are cut through as well as punched through (line 102).

If fluid flows back through the vacuum line in the direction of housing 14, so the first one mentioned reaches the area between outer space 70 (in FIG. 4 areas 95, 97) of the flexible first element 66 and inner space of the tube-like lug 52, whereby the check valve 64 is closed. Arrows 74 symbolize the stream of the fluid.

The fluid collected in the gap between the outer space 70, 95, 97 of the flexible first element 66 and the interior wall 72 of the tube-like lug 52 consequently exercises a clamping force on the hose section 66.

As soon as the necessary pressure arises in the vacuum line, the fluid is siphoned off and the check valve 64 is opened due to the prevailing pressure, so that with an open valve, fluid and solids can be siphoned off by the tube-like lug 50.

What is claimed is:

1. A vacuum drainage system with a vacuum line connected with a vacuum source, in which a vacuum valve (10) is arranged between a collection point collecting accumulated waste water and the vacuum source that exhibits a housing, which exhibits a vacuum side housing part (53) added to the vacuum side of the vacuum line as well as a converged housing (51) part added to the converge-sized vacuum line, whereby preferably a flexible, especially tube-like first element (12) of the vacuum valve is arranged in the housing, admittable with pressure between the housing and available space (48) of the first element and with the closed vacuum valve, the first element is pulled together by caulk running preferably linear or lamellar to the longitudinal axis of the area (18,19) of the first element, thereby characterized, that a check valve (64) blocking the back flush of waste water in the vacuum-sided cabinet section (53) of the vacuum valve (10).

2. Vacuum drainage system according to claim 1, characterized in that the vacuum-sided housing section (53) is a housing's lug.

3. Vacuum drainage system according to claim 1, characterized in that the check valve (64) comes from the housing (14) of the vacuum valve (10) and a tube-like section or attempt (52) of the housing, respectively.

4. Vacuum drainage system according to claim 1, characterized in that the check valve (64) is or exhibits a flexible second element (66), which exhibits the geometry of an isosceles triangle in a sealed or closed position in a first lateral view, and the geometry of a quadrangle in a lateral view displaced to a 90° lateral view.

5. Vacuum drainage system according to claim 1, characterized in that the flexible second element (66) exhibits a hollow cylindrical base section (82), from which, in the closed position of the check valve, two diametrically opposed hollow cylindrical sections (86, 88), exhibiting triangle geometry, lying across from each other, in lateral view of the check valve resulting from one peak (90, 92) are each connected with planned sections (94, 96) at least outside, which are separated by a straight line connected with the peaks (90, 92) of the hollow cylindrical sections (86, 88) in the area.

6. Vacuum drainage system according to claim 4, characterized in that an edge (98, 100) running along the straight line of the at least the outside planned section (94, 96) of each flexible second element (66) is a sealing lip.

7. Vacuum drainage system according to claim 1, characterized in that the flexible second element (66) is fixed by a revolving edge (76), showing a U-shape in the cut, of the base section in the housing (14) and the tube-like lug (52) or between both.

8. Vacuum drainage system according to claim 1, characterized in that the first and/or second flexible element (12, 66) consist(s) of or contains elastomer material.

9. Vacuum drainage system according to claim 1, characterized in that the first and/or second flexible element (12, 66) is a spraying part.
